(19) United States
(12) Patent Application Publication
(10) Pub. No.: US 2008/0025789 A1
(43) Pub. Date: Jan. 31, 2008

(54) Fixing boss structure

(75) Inventor: Tzu-Chih Lin, Hsinchu County (TW)

Correspondence Address: BIRCH STEWART KOLASCH & BIRCH, PO BOX 747, FALLS CHURCH, VA, 22040-0747, US

(73) Assignee: Altek Corporation

(21) Appl. No.: 11/636,601

(22) Filed: Dec. 11, 2006

(30) Foreign Application Priority Data
Jul. 26, 2006 (TW) 095213164

(51) Int. Cl. G05G 1/12

(52) U.S. Cl. 403/361

(57) ABSTRACT

A fixing boss structure disposed on a housing having a plurality of blind holes is provided, which includes a post and a pressing part that disposed at one end of the post. A combining hole is opened inside the post, and the outside diameter of the pressing part is larger than the inside diameter of the blind hole, so as to force the pressing part to be pressed and fixed inside the blind hole.

### CROSS-REFERENCE TO RELATED APPLICATIONS

This non-provisional application claims priority under 35 U.S.C. § 119(a) on Patent Application No(s). 095213164 filed in Taiwan, R.O.C. on Jul. 26, 2006, the entire contents of which are hereby incorporated by reference.

### BACKGROUND OF THE INVENTION

1. Field of Invention

The present invention relates to a fixing boss structure, and more particularly to a fixing boss structure which is fixed inside the blind hole in a tight fit.

2. Related Art

Nowadays with the flourishing development of technology and information, electronic products with convenient functions have become indispensable products at work or in life, for example, notebooks and desktop computers have become more and more popular, and even the number of servers in companies and enterprises for business is also increased day by day. For conveniently electrically disposing electronic component parts on the circuit board of the electronic products, a plurality of fixing bosses are commonly preset on the circuit board, so as to make the electronic component parts and the circuit board separated by the fixing bosses, and combined by screwing with a screw.

Several common conventional methods are provided in order to fix the fixing boss at the preset position of the circuit board. The first conventional method is adhering the fixing boss to fix it on the circuit board by the adhesive. The second method is embedding the fixing boss into the circuit board in a loose fit manner, and soldering the fixing boss by the solder to fix it on the circuit board. The third method is directly forming the fixing boss at the preset position of the circuit board with one-piece technology. Or otherwise, the fixing boss passes through the preset fixing hole on the circuit board, and a plastic inner cap matching the fixing boss is fitted on one end of the fixing boss which passes through the circuit board, such that the fixing boss is fixed on the circuit board without being separated from it.

But the volume of the current electronic products tends to be smaller, and the inside circuit board and the electronic component parts also scale down significantly, such that the fixing boss has to fit so as to relatively reduce its size and spacing, and the circuit disposed on the circuit board has to pass by the preset position of the fixing boss, so as to avoid being in contact with the fixing boss and destroying the circuit distribution, thus the circuit layout of the circuit board is more difficult, the circuit distribution is more complicated, and the manufacturing cost is increased significantly.

In the fixing process of the fixing boss performed with the adhering or soldering manner of conventional art, the bonding strength of the adhesive or the solder is influenced due to the material and the surface state of the fixing boss. If the fixing boss is formed with a conventional integral injection molding, the mechanical strength of the fixing boss made of plastic material is not preferable, thus the shelling of the fixing boss because of the unavoidable collision and shaking is easy to be caused during the process of delivering the electronic products. If the manner of making the plastic inner cap fit on the fixing boss to fix the circuit board is used, the whole volume and thickness of the electronic products are increased, and it does not complies the demand for the electronic products as being light and thin.

### SUMMARY OF THE INVENTION

In view of the above problems, the object of the present invention is to provide a fixing boss structure, so as to eliminate the limits or disadvantages in prior art that it is not easy to dispose the fixing boss in microelectrode device, and the bonding strength is not preferable by the manner of adhering or soldering.

To achieve the abovementioned object, the fixing boss structure of the present invention is disposed on a housing having a plurality of blind holes, which comprises a post and a pressing part that disposed at one end of the post, wherein a combining hole is opened inside the post, and the outside diameter of the pressing part is larger than the inside diameter of the blind hole, so as to force the pressing part to be pressed and fixed inside the blind hole.

The function of the present invention lies in that, the body of the fixing boss is pressed inside the blind holes of the housing by the manner of tight fit, the position for disposing the fixing boss structure is not limited by the circuit distribution, and the bonding strength between the fixing boss and the housing is preferable, thus it is not easy to shell because of collision, and the volume and thickness of the whole electronic device are not increased due to the disposition of the fixing boss.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic exploded view of the first embodiment according to the present invention;

FIG. 1B is a schematic combined view of the first embodiment according to the present invention;

FIG. 2A is a schematic exploded view of the second embodiment according to the present invention;

FIG. 2B is a schematic combined view of the second embodiment according to the present invention; and

FIG. 2C is a partially enlarged schematic view of the second embodiment according to the present invention.

### DETAILED DESCRIPTION OF THE INVENTION

To make the object, structure, features, and functions of the present invention more comprehensible, the present invention is illustrated in detail below with reference to the embodiments.

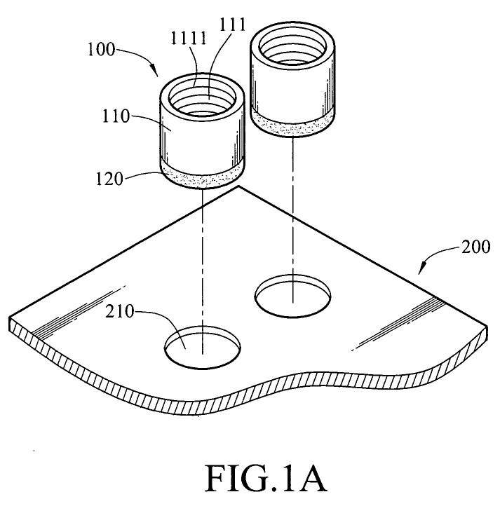

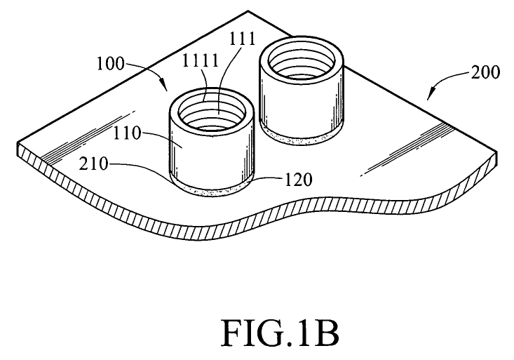

FIG. 1A and FIG. 1B are schematic stereograms of the first embodiment according to the present invention. As shown in the figures, the fixing boss structure 100 the present invention is disposed on a housing 200 having a plurality of blind holes 210, wherein the material of the housing 200 may be either metal material or plastic material. The fixing boss structure 100 includes a post 110 and a pressing part 120 that disposed at one end of the post 110, wherein the post 110 is a cylindrical structure, but those skilled in the art may change the design of the post 110 as a post with polygonal structure, which is not limited by the embodiment disclosed in the present invention. A combining hole 111 is opened along the axial position inside the post 110, which is used to be combined or disassembled with fixing components (not shown), e.g., fixing elements such as pin or bolt, so as to facilitate the user to add electronic component parts at the preset position. The outside diameter of the pressing part 120 is larger than the inside diameter of the blind hole 210, and the size and material hardness of the pressing part 120 is larger than those of the blind hole 210, thus the pressing part 120 is forced to be pressed and fixed inside the blind hole 210, such that the post 110 is steadily embedded and fixed on the housing 200 without being separated from it.

As shown in FIG. 1A, a screw thread 1111 is disposed on the inner side of the combing hole 111 of the post 110, so that the user may lock the bolt on the post 110. The surface of the pressing part 120 engaged with the blind hole 210 is a rough surface, so as to increase the friction between the blind hole 210 and the surface, such that the post 110 is not easy to be separated from the housing 200. The rough surface of the pressing part 120 may be formed by sand blasting process or other mechanical treatment methods. In addition, during the process of manufacturing, the fixing boss structure 110 is embedded and fixed inside the housing 200 by a tight fit manner, and a rust proof treatment is performed on the surface of the fixing boss structure 110, so as to increase the appearance quality and the service life of the fixing boss structure 110.

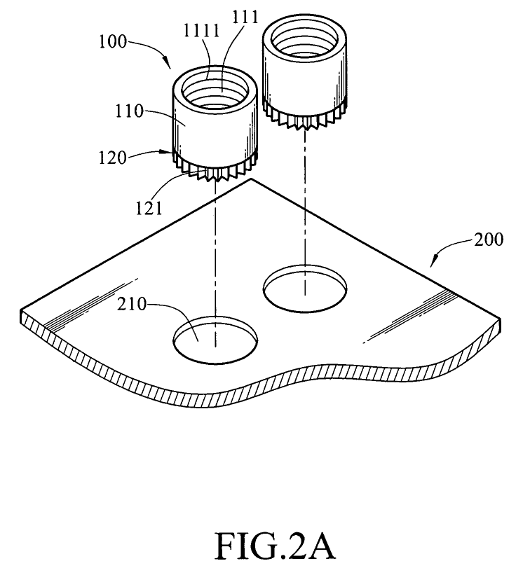

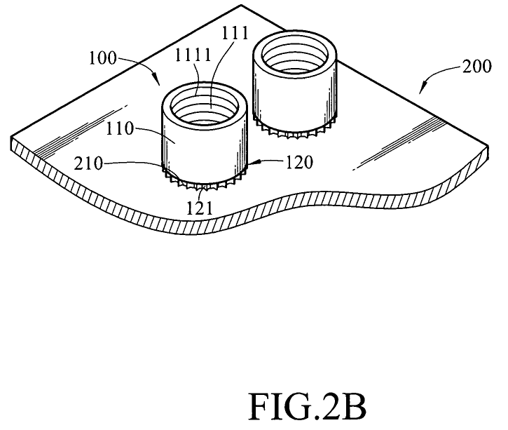

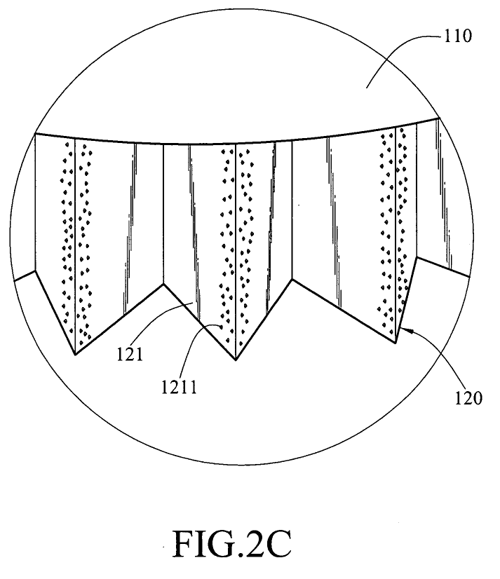

FIG. 2A and FIG. 2B are schematic stereograms of the second embodiment according to the present invention. As shown in the figures, the pressing part 120 has a surrounding conical gear 121 arranged in a fixed spacing around the post 110. The conical gear 121 having a tip structure is forced to be pressed inside the blind hole 210, and the tip portion and the outer edge of the blind hole 210 are deformed to be engaged with each other, so as to significantly increase the bonding strength of the pressing part 120 with respect to the blind hole 210 having lower hardness. As for the user, it is easier to force the pressing part 120 to be pressed and embedded inside the blind hole 210.

FIG. 2C is a partially enlarged schematic view of the surrounding conical gear 121 according to the second embodiment of the present invention. As shown in the figure, a zigzag texture 1211 may further be disposed at the tip of the surrounding conical gear 121, such that the friction of the pressing part 120 for engaging the blind hole 210 is increased, and the bonding strength between the post 110 and the housing 200 is increased, so as to avoid the problem of shelling because of insufficient strength.

In the present invention, the post is pressed to be disposed inside the blind hole of the housing by a tight fit method, the disposition position of the fixing boss structure of the present invention is not limited by the circuit layout of the circuit board, and the bonding strength between the fixing boss and the housing is preferable and complies the current demand for the volume of the electronic device as being light and thin.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fixing boss structure disposed on a housing having a plurality of blind holes, comprising:
a post, having a combing hole opened therein; and
a pressing part, disposed at one end of said post, wherein the outside diameter of said pressing part is larger than the inside diameter of the blind hole, so as to force said pressing part to be pressed and fixed inside the blind hole.

2. The fixing boss structure as claimed in claim 1, wherein the combining hole is further provided with a screw thread.

3. The fixing boss structure as claimed in claim 1, wherein the surface of said pressing part is a rough surface.

4. The fixing boss structure as claimed in claim 1, wherein said pressing part further has a surrounding conical gear.

5. The fixing boss structure as claimed in claim 4, wherein the tip of the surrounding conical gear is further provided with a texture.
